(19) United States
(12) Patent Application Publication
(10) Pub. No.: US 2002/0019467 A1
(43) Pub. Date: Feb. 14, 2002

(54) Binder composition for powder coatings

(75) Inventors: Rudolfus A.T.M. Van Benthem, Sittard (NL); Patrick H.M. Hendricks, Beek (NL); Johan Rietberg, Zwolle (NL)

Correspondence Address: Pillsbury Madison & Sutro, LLP, Intellectual Property Group, East Tower, Ninth Floor, 1100 New York Avenue, N.W., Washington, DC, 20005-3918, US

(73) Assignee: DSM N.V., Heerlen (NL)

(21) Appl. No.: 09/934,682

(22) Filed: Aug. 23, 2001

Related U.S. Application Data
(63) Continuation of application No. PCT/NL00/00120, filed on Feb. 24, 2000.

(30) Foreign Application Priority Data
Feb. 26, 1999 (NL) 1011403

(51) Int. Cl. C08K 5/5313

(52) U.S. Cl. 524/126

(57) ABSTRACT

The invention relates to a powder paint binder composition which contains a compound comprising carboxylic acid units, a compound comprising hydroxyalkyl amide units and as catalyst phosphinic acid, a (C₁-C₂₆) alkylphosphinic acid, a (C₆-C₂₀) arylphosphinic acid or an ester or an anhydride derived from one of these acids. Highly suitable as catalyst for this reaction are phosphinic acid, phenylphosphinic acid and diylphosphine ester acid.

The invention relates to a powder paint binder composition which contains a compound comprising hydroxyalkyl amide units and a compound comprising carboxylic acid units.

As appears from WO-A-95/01406, in which a powder paint composition containing a carboxyl functional aliphatic polyester and a β-hydroxyalkyl amide crosslinker is described, it is assumed that the reaction between a hydroxyalkyl amide and a compound containing carboxylic acid groups is difficult to catalyze.

The object of the invention is to accelerate the reaction between a compound based on an aromatic carboxylic acid, such as for instance an aromatic polyester, and a hydroxyalkyl amide.

The invention is characterized in that the catalyst used for the reaction between the compound containing carboxylic acid units and the compound containing hydroxylamide units is phosphinic acid, a (C₁-C₂₆) alkylphosphinic acid, a (C₆-C₂₀) arylphosphinic acid or an ester or an anhydride derived from one of these acids.

According to a preferred embodiment of the invention the catalyst is a compound according to any of the formulas (I) or (II):

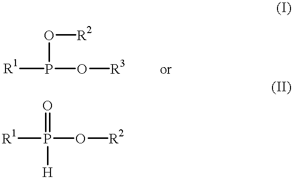

where

R¹=H, (C₁-C₂₆)alkyl or (C₆-C₂₀)aryl

R²=H (C₁-C₂₆)alkyl or (C₆-C₂₀)aryl and

R³=H, (C₁-C₂₆)alkyl or (C₆-C₂₀)aryl.

Due to the use of this catalyst the rate of the curing reaction between a β-hydroxyalkyl amide crosslinker and a polymer containing an acid group is raised considerably, resulting in improved final curing. Moreover, a lower curing temperature and/or a shorter curing time will suffice.

Preferably the catalyst is phosphinic acid (H₃PO₂), (C₁-C₂₆) alkylphosphinic acid or (C₆-C₂₀) arylphosphinic acid. A suitable catalyst with a cyclic structure is for instance 1,8-naphthalene diylphosphinic ester acid (for instance Struktol Polydis PD 3710™)

In a further preferred embodiment of the invention the catalyst is phosphinic acid, phenylphosphinic acid or 1,8-naphthalene diylphosphinic ester acid.

The selection of the catalyst can be governed by the desired properties, the application and the chosen curing cycles.

The quantity of catalyst may range between 0.05 and 2 wt. % (relative to the binder composition) and is preferably between 0.1 and 1 wt. %.

The weight ratio between the carboxylic acid compound and the hydroxyalkyl amide compound may range between 70:30 and 97:3, and is preferably between 80:20 and 95:5. The selection of this ratio can be governed by the envisaged application.

Examples of suitable compounds containing hydroxyalkyl amide units are compounds having a structure formula according to formula (III):

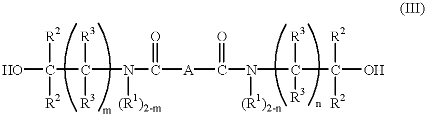

where:

A is a mono- or polyvalent organic group, derived from a saturated or non-saturated alkyl group having 1-60 carbon atoms (for instance ethyl, methyl, propyl, butyl, pentyl, hexyl, heptyl, octyl, nonyl, decyl, eicosyl, triacontyl, tetracontyl, pentacontyl, hexacontyl and the like); an aryl group, such as phenyl, naphthyl and the like; a trialkylene amino group, with 1-4 carbon atoms per alkylene group, for instance trimethylene amino, triethylene amino and the like; or an unsaturated residue with one or more alkenic groups (—C=C—) with (1-4) carbon atoms, such as for instance ethenyl, 1-methylethenyl, 3-butenyl-1,3-diyl, 2-propenyl-1,2-diyl, a carboxyalkenyl group, for instance a 3-carboxy 2-propenyl group and the like, an alkoxycarbonylalkenyl group with (1-4) carbon atoms, such as for instance a 3-methoxycarbonyl-2- propenyl group and the like;

R¹ is hydrogen, an alkyl group with 1-5 carbon atoms (for instance methyl, ethyl, n-propyl, n-butyl, sec. butyl, tert. butyl, pentyl and the like) or a hydroxyalkyl group with 1-5 carbon atoms (for instance 3-hydroxypropyl, 4-hydroxybutyl, 3-hydroxy-butyl or de hydroxy derivatives of the pentyl isomers);

R² and R³ are identical or different and each represent hydrogen or a straight or branched alkyl group with 1-5 carbon atoms, while one of the groups R² and one of the groups R³ together with the adjacent carbon atoms can also form a cycloalkyl group, such as for instance cyclopentyl and cyclohexyl; R² and R³ can also be hydroxyalkyl groups, such as for instance hydroxy(C₁-C₅)alkyl groups, preference being given to hydroxymethyl and 1-hydroxyethyl, and

n and m independently of each other have a value of between 0 and 2.

Preferably, A (C₁-C₁₀)alkyl or hydrogen, R¹ hydrogen and R and R=hydrogen or hydroxy (C₁-C₂)alkyl.

Preferred embodiments of the compound according to formula (III) are compounds according to formulas (IV) and (V):

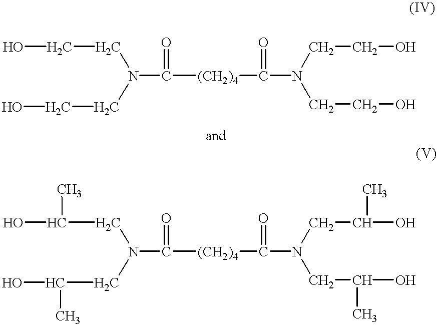

A suitable compound according to formula (IV) is commercially available as Primid XL552™ and a suitable compound according to formula (V) is commercially available as Primid QM1260™.

It is also possible to use as the compound containing hydroxyalkyl amide groups a condensation polymer as disclosed in for example WO-A-99/16810. This polymer may contain hydroxyalkyl amide groups having a weight average molecular mass of between 800 and 50000 g/mol, a number average molecular mass of between 600 and 10000 and a hydroxyalkylamide functionality of between 2 and 250.

This polymer may contain at least a group according to formula (VI)

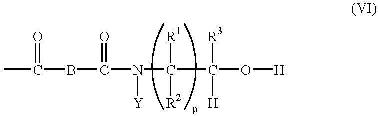

where

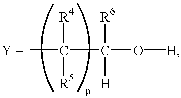

H, (C₁-C₂₀)(cyclo)alkyl, or (C₆-C₁₀) aryl

B=(C₂-C₂₀), optionally substituted, aryl or (cyclo)alkyl aliphatic diradical, R¹, R², R³, R⁴, R⁵ and R⁶ are identical or different, and independently of each other can be H, (C₆-C₁₀) aryl- or (C₁-C₈) (cyclo)alkyl radicals and p=1−4.

Preferably p=1.

The polymer containing β-hydroxyalkyl amide groups may be a polymer according to formula (VII):

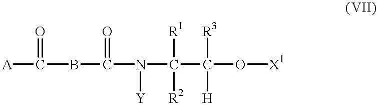

where:

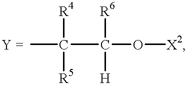

H, (C₁-C₂₀)(cyclo)alkyl or (C₆-C₁₀)aryl

B=(C₂-C₂₀), optionally substituted, aryl or (cyclo)alkyl aliphatic diradical,

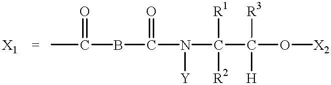

X₂=H or X¹ and R¹, R², R³, R⁴, R⁵ and R⁶ are identical or different, and independently of each other can be H, (C₆-C₁₀) aryl or (C₁-C₈) (cyclo)alkyl radicals or CH₂-OX².

In all formulas, R groups together or with adjacent carbon atoms can form part of a cycloalkyl group or a cycloaryl group.

In a preferred embodiment the polymer containing β-hydroxyalkyl amide groups is a polymer according to formula (VIII):

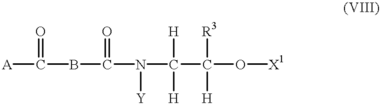

where:

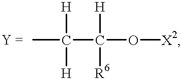

H, (C₁-C₂₀) (cyclo)alkyl or (C₆-ClO) aryl,

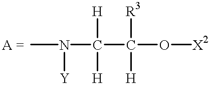

or OH,

B=(C₂-C₂₀), optionally substituted, an aryl or (cyclo)alkyl aliphatic diradical,

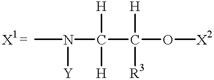

X²=H or X^{1,}

R³=H or (C₆-C₁₀) aryl or (C₁-C₈)alkyl radical and

R⁶=H or (C₆-C₁₀) aryl or (C₁-C₈)alkyl radical.

Copolymers that are hydroxylamide functional as well as carboxyl or anhydride functional can also be used, as can self-curing polymers.

Such polymers are described for instance in U.S. Pat. No. 4138541 and U.S. Pat. No. 4101606.

Monomers, oligomers and polymers are suitable for use as compounds containing carboxylic acid groups.

Examples of suitable monomers are (C₁-C₂₆) alkyl carboxylates, (C₆-C₂₀)aryl carboxylates and unsaturated carboxylic acids, such as for instance (meth)acrylic acid, crotonic acid, semi-esters of itaconic acid, maleic acid and fumaric acid.

Examples of suitable polymers include polyesters, polystyrenes, polyacrylates and polyurethanes containing carboxyl groups.

By preference, polyesters are used.

The preparation of thermosetting powder coatings in general and the chemical curing reactions of powder paints to cured coatings are described by Misev in Powder Coatings, Chemistry and Technology (1991, John Wiley) on pp. 42-54, pp. 148 and 224-226. A thermosetting binder composition is usually defined as the resinous part of the powder paint consisting of polymer and crosslinker.

The catalyst can be added during or after the preparation of the polyester. The catalyst is preferably added during the preparation of the powder paint.

Phosphinic acid and phenylphosphinic acid are the preferred catalyst for use in powder paint composition.

In a further preferred embodiment of the invention an aqueous solution, for instance a 50 wt. % solution, of phosphinic acid is used as catalyst.

If desired, the usual additives such as for instance pigments, fillers, degassing agents, flow-promoting agents and stabilizers can be incorporated in the binder composition and the powder paint system.

The binder composition according to the invention can be used in compositions with pigments as well as in compositions without pigments.

In a preferred embodiment of the invention the binder composition is used in a non-pigmented powder paint system (“clearcoat”).

If pigments are used, those that have no interaction with the selected catalyst are preferred. If pigments are used, organic pigments are suitable for instance, such as titanium dioxide, zinc sulphide, iron oxide and chromium oxide, as well as organic pigments, such as for instance azo compounds.

Suitable fillers include for instance metal oxides, silicates, carbonates and sulphates.

Suitable stabilizers include for instance primary and/or secondary antioxidants, UV stabilizers, such as for instance quinones, (sterically hindered) phenolic compounds, phosphonites, phosphites, thioethers and HALS (hindered amine light stabilizers) compounds.

Examples of degassing agents are benzoin and cyclohexane dimethanol bisbenzoate. The range of flow-promoting agents includes for instance polyalkyl acrylates, fluorocarbons and silicon oils. Other suitable additives are for instance additives for improvement of the triboelectric chargeability, such as sterically hindered tertiary amines which are described in EP-B-371528.

Powder paints according to the invention can be applied in the customary manner, for instance by electrostatic spraying of the powder onto an earthed substrate and curing the paint by exposing it to heat at a suitable temperature and for a sufficiently long time. The applied powder can be heated for instance in a gas oven or an electric oven or by means of infrared irradiation.

Thermosetting coatings based on powder paint compositions for industrial applications are further described in a general sense in Powder Coatings, Chemistry and Technology, Misev, pp. 141-173 (1991).

Compositions according to the present invention can be applied in powder paint compositions for use on, for instance, metal, wood and plastic substrates. Examples are industrial coatings, coatings for machines and tools, domestic applications and component parts of buildings. The coatings are further suitable for use in the automotive industry for coating of parts and accessories.

The systems according to the invention can also be used for instance in other technical fields of the coating industry, in printing ink applications and in the technical field of adhesives applications.

Also WO-A-98/30627 discloses that the use of a catalyst is only marginally effective in accelerating the reaction of β-hydroxyl amides. The solution disclosed in WO-A-98/30627 for the stated problem is to replace β-hydroxylamide by hydroxylalkyl urea.

The invention will now be elucidated by means of the following non-restrictive examples.

### EXPERIMENT 1

Preparation of a Compound Containing Hydroxyalkyl Amide Units

232 g phthalic anhydride and 270 g diisopropanol amine were introduced into a double-walled glass reactor, heatable with heating oil, provided with a mechanical stirrer, a distillation head and nitrogen supply and vacuum connections. With stirring the reaction mixture was gradually heated to approx. 70° C. and then at a lower rate to 170° C. During the heating a vacuum was applied. The pressure in the reactor was adapted to the release of reaction water, so that this could removed out of the reactor by distillation. After a total reaction time of 5 hours the viscous polymer contained less than 0.2 meq/g carboxylic acid (determined titrimetrically) and it was not possible any more to distil off water. After cooling the polymer was obtained. The hydroxyl groups Acontent was found titrimetrically to be 5.8 meq/g. The number average molecular mass was determined by means of GPC (universal calibration) to be 1100 g/mol; and the weight average molecular mass was 4900 g/mol.

### EXAMPLES I-II

Powder Paint Composition

By mixing and extruding (PRISM extruder, 100° C.) of 170 parts by weight of a carboxyl functional polyester (Uralac P₈₆₀™ from DSM Resins), 30 parts by weight of the compound obtained in Experiment 1, furthermore 2 and 4, respectively, parts by weight of H₃PO₂ (50% in water) and the additives (as indicated in Table 1) powder paint compositions were prepared in the customary manner.

The compositions were ground, screened and sprayed electrostatically (Corona) on aluminium test panels in the customary manner. After a cure cycle of 10 minutes at 200° C. in a hot-air oven the panels were tested for reverse impact resistance (ASTM-2794/69 in inches per pound). The gel time is determined according to DIN 55990. The test results are shown in Table 1.

### Comparative Example A

Example I was repeated without the addition of H₃PO2

TABLE 1

| | I | II | A |
|---|---|---|---|
| Uralac P860 ™ | 170 | 170 | 170 |
| Comp. According to Exp. 1 | 30 | 30 | 30 |
| H₃PO₂ (50% in water) | 2 | 4 | 0 |
| Resiflow PV5 ™ | 3 | 3 | 3 |
| Benzoin | 0,8 | 0,8 | 0,8 |
| Gel time before extrusion (sec) | 130 | 86 | 220 |
| Gel time after extrusion (sec) | 100 | 90 | 220 |
| Gradient 10′ 200° C. impact at ° C. | 160 | 170 | 192 |

From these examples it appears that the temperature at which full impact (160 ip) is obtained is lower for a system according to the invention. This is an indication of a more reactive system. In addition, the gel times are lower, which means that the curing reaction rates are higher.

1. A powder paint binder composition containing a compound comprising carboxylic acid units, a compound comprising hydroxyalkyl amide units and a catalyst, characterized in that the catalyst is phosphinic acid, a (C₁-C₂₆) alkylphosphinic acid, a (C₆-C₂₀) arylphosphinic acid or an ester or an anhydride derived from one of these acids.

2. A composition according to claim 1, characterized in that the catalyst is a compound according to any one formulas (I) or (II): 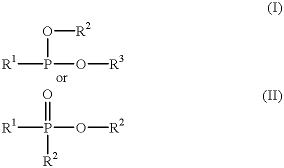
where
R¹=H, (C₁-C₂₆)alkyl or (C₆-C₂₀)aryl
R²=H. (C₁-C₂₆)alkyl or (C₆-C₂₀)aryl and
R³=H. (C₁-C₂₆)alkyl or (C₆-C₂₀)aryl.

3. A composition according to any one of claims 1-2, characterized in that the catalyst is phosphinic acid, (C₁-C₂₆)-alkylphosphinic acid or (C₆-C₂₀) arylphosphinic acid.

4. A composition according to claim 3, characterized in that the catalyst is phosphinic acid, phenylphosphinic acid or 1,8 naphthalene diylphosphine ester acid.

5. A process for the reaction between a compound comprising hydroxyalkyl amide units and a compound comprising carboxylic acid units in the presence of a catalyst according to any one of claims 1-4.

6. A powder paint composition comprising a binder composition according to any one of claims 1-4.

7. A non-pigmented powder paint composition comprising a binder composition according to any one of claims 1-4.

8. A powder coating obtained by curing a powder paint composition according to any one of claims 6-7.

9. Wholly or partly coated substrate, characterized in that the coating applied is a powder coating according to claim 8.
